(19) United States
(12) Patent Application Publication
(10) Pub. No.: US 2009/0182622 A1
(43) Pub. Date: Jul. 16, 2009

(54) ENHANCING AND STORING DATA FOR RECALL AND USE

(76) Inventors: Amit D. Agarwal, Mercer Island, WA (US); Samuel P. Hall, VI, Bellevue, WA (US); Elisabeth L. Rode, Seattle, WA (US); Jeffrey P. Bezos, Greater Seattle Area, WA (US)

Correspondence Address: Knobbe, Martens, Olson & Bear, LLP, 2040 Main Street, Fourteenth Floor, Irvine, CA, 92614, US

(21) Appl. No.: 12/200,822

(22) Filed: Aug. 28, 2008

Related U.S. Application Data
(60) Provisional application No. 61/021,275, filed on Jan. 15, 2008.

(51) Int. Cl. G06Q 30/00; G06F 17/30; G06F 7/00

(52) U.S. Cl. 705/10; 707/102; 707/3; 705/14; 705/26; 707/E17.014; 707/E17.044

(57) ABSTRACT

A user of a personal computing device may see an item that interests him or her and would like to remember the item for future reference. The user captures data (e.g., a digital image, an audio recording, etc.) of the item of interest (e.g., anything user can see, hear or touch) and submits the captured data to the memory enhancement service for enhancement and storage. The memory enhancement service submits the captured data to a human interaction task system for enhancement. More specifically, the human interaction task system distributes the captured data to one or more human workers to identify the item subject of the captured data, determine the user's interest in the item subject of the captured data, and provide information regarding the item that may be relevant to the user based on this determined interest. The enhanced data returned from the human interaction task system is then stored by the memory enhancement service for subsequent recall by the user and possible use by the user or others.

### CROSS-REFERENCE TO RELATED APPLICATIONS

The present patent application claims priority to U.S. Provisional Patent Application Ser. No. 61/021,275, to Rode et al., entitled “Systems and Methods of Retrieving Information,” filed Jan. 15, 2008. The entire content of this provisional patent application is incorporated herein by reference.

### BACKGROUND

Generally described, computing devices and communication networks facilitate the collection, storage and exchange of information. In common applications, computing devices, such as personal computing devices, are used to store a variety of information on behalf of their users, such as calendar information, personal information, contact information, photos, music and documents, just to name a few.

In an increasingly mobile society, users frequently come across items in which they are interested and would like to remember for later use. Accordingly, the user may record some information regarding an item using their personal computing device and store it for later retrieval. For example, a user may take and store a digital image of an item using the camera functionality on his or her mobile phone. The user may also attach the image to an electronic message (e.g., an electronic mail message) and transmit the image including whatever notes the user may have made about the image, to the user's electronic mail account for retrieval at a later time, or alternatively, to another contact. In yet another example, the user may record a voice notation regarding the item using his or her personal computing device and store it for later retrieval, or similarly, transmit the recorded voice notation elsewhere for storage and later retrieval.

In yet other applications, users may submit questions or queries regarding an item of interest via a communication network to a network-based service (e.g., a web service) capable of processing and responding to the query or question. For example, a user can submit a question to such a service via email from the user's personal computing device. The service may employ automated algorithms for processing the query and returning an answer, or may submit the query to a group of human workers who attempt to answer the query.

While the applications described above enable a user to store information regarding an item of interest for later retrieval or provide additional information regarding items of interest to the user, these applications are limited to merely storing information as specifically input by the user or storing information in the form of a response to a specific query from the user.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a block diagram depicting an illustrative operating environment in which a memory enhancement service enhances and stores data captured by a capture device regarding items of interest to a user;

FIG. 2 is a block diagram of certain illustrative components implemented by the memory enhancement service shown in FIG. 1;

FIG. 3A is a block diagram of the operating environment of FIG. 1 illustrating a capture device submitting a request to the memory enhancement service to enhance and store captured data on behalf of the user;

FIG. 3B is a block diagram of the operating environment of FIG. 1 illustrating the memory enhancement service forwarding a request regarding the user's enhanced and stored data to at least one other network-based service for further processing and/or use;

FIG. 4 is a flow diagram of an illustrative routine implemented by the memory enhancement service to enhance data captured by the capture device;

FIGS. 5A-5D are illustrative user interfaces generated on a capture device for enabling a user to capture data regarding items of interest, submit a request to enhance and store captured data to the memory enhancement service and view enhanced and stored data regarding the item of interest provided by the memory enhancement service;

FIG. 6 is a block diagram of the operating environment of FIG. 1 illustrating a client device submitting a request regarding the user's enhanced and stored data to the memory enhancement service;

FIGS. 7A and 7B are illustrative user interfaces generated on the client device for displaying information regarding the user's enhanced and stored data that is provided by the memory enhancement service;

FIG. 8 is an alternative, illustrative user interface generated on the client device for displaying information regarding the user's enhanced and stored data that is provided by the memory enhancement service;

FIG. 9 is a block diagram of the operating environment of FIG. 1 illustrating the user's client device submitting a request to the memory enhancement service to share the user's enhanced and stored data with the user's contacts; and

FIG. 10 is an illustrative user interface generated on a contact's client device for displaying the enhanced and stored data that is being shared by the user.

### DETAILED DESCRIPTION

Generally described, aspects of the present disclosure relate to enhancing data captured by a user regarding an item of interest and storing the enhanced data for subsequent recall by the user, sharing, and possible use by the user or others. In this regard, a memory enhancement service is described that enhances and stores the captured data on behalf of the user. For example, the user of a capture device, such as a mobile phone, may see an item that interests him or her and would like to remember the item for future reference. The item of interest may be anything, for example, anything a person can see, hear, imagine, think about or touch. Accordingly, the item of interest may be an object (such as an article of manufacture, plant, animal or person), a place (such as a building, park, business, landmark or address), or an event (such as a game, concert or movie). In one embodiment, the user may capture an image of the object, place or event (e.g., using the camera functionality of his or her mobile phone) and submit the image to the memory enhancement service for enhancement and storage.

As will be described in more detail below, the memory enhancement service may submit the captured data to a human interaction task system for enhancement. More specifically, the human interaction task system distributes the captured data to one or more human workers to identify the item that is subject of the captured data, determine the user's interest in the item that is subject of the captured data, and provide information regarding the item that may be relevant to the user based on this determined interest. Because the memory enhancement service employs a human interaction task system to process the captured data rather than automated algorithms and/or other forms of artificial intelligence, the risk of misidentification of the captured data is minimized and the scope and variety of information that can be provided by the human interaction task system is virtually unlimited.

In one example, the capture device is a personal computing device (e.g., a mobile phone) equipped with an image capture element (e.g., a camera). Using the camera functionality of the mobile phone, the user may capture digital images of items of interest as the user encounters such items. For example, a user may capture an image of an object such as a bottle of wine and submit the captured image to the memory enhancement service. The memory enhancement service submits the captured image to the human interaction task system, where the human workers who process the captured image may identify the item of interest from the captured image as a particular bottle of wine and determine that the user is interested in the rating of the bottle of wine found in the image. Thus, the human workers may obtain the rating for the subject bottle of wine and return it to the memory enhancement service. The memory enhancement service may store the enhanced data (including the image of the bottle of wine, the name and the rating) in a memory account associated with the user and then return the enhanced and stored data to the user's mobile phone. Alternatively, the human workers may determine that the user is interested in local wine shops which stock the subject bottle of wine and thus, may return location information for such wine shops to the memory enhancement service. As with the previous example, the memory enhancement service may store this enhanced data in the user's memory account and return the enhanced and stored data to the user's mobile phone. As yet another possibility, if the subject bottle of wine is available for purchase via a network-based retail service, the memory enhancement service may provide the user with the option of purchasing the bottle of wine directly from the retail service utilizing his or her mobile phone and have it delivered to a designated location.

In another embodiment, the item of interest may be a musical song that the user would like to remember. In such cases, if the capture device is equipped with a microphone and an audio recording component, the user may record a sample of the song and submit the captured audio recording of the sample to the memory enhancement service. In another embodiment, the user may utilize the capture device to record the user as he or she speaks, sings or even hums a portion of the song that the user wishes to remember. In such cases, the capture device may be utilized to submit a request to enhance and store the audio recording to the memory enhancement service. The memory enhancement service may further enhance the captured data (e.g., the audio recording) and store the audio recording in the memory account associated with the user. For example, the memory enhancement service (utilizing a human interaction task system) may identify the song by name, artist, album, year recorded, etc. In addition, the memory enhancement service may determine the user's interest in the identified song and provide information related thereto. For example, the information may include a concert schedule for the artist who has recorded the song, an option to purchase the song, a list of other versions of the song recorded by different artists, a commercially available sample of the song hummed by the user, etc. As noted above, because the request to enhance and store the captured data (e.g., the audio recording) is eventually processed by a human interaction task system, a wide variety of possible enhancements to the captured data may be found and deemed appropriate.

In yet another illustrative example, the capture device may be utilized to capture manual input from the user. For instance, the user may request that the memory enhancement service enhance and store a notation the user has made via a keyboard, touch screen or stylus with which the capture device is equipped. Such a notation may be a drawing, a few written words, one or more symbols, etc. The memory enhancement service further enhances the captured data by submitting it to the human interaction task system. The human interaction task system processes the captured data and provides enhanced data. For example, if the notation includes a logo for a major league baseball team, the enhanced data returned by the human interaction task system may identify the team and include the current schedule for the team, directions to their stadium, or the most recent news articles regarding the this team, just to name a few non-limiting examples.

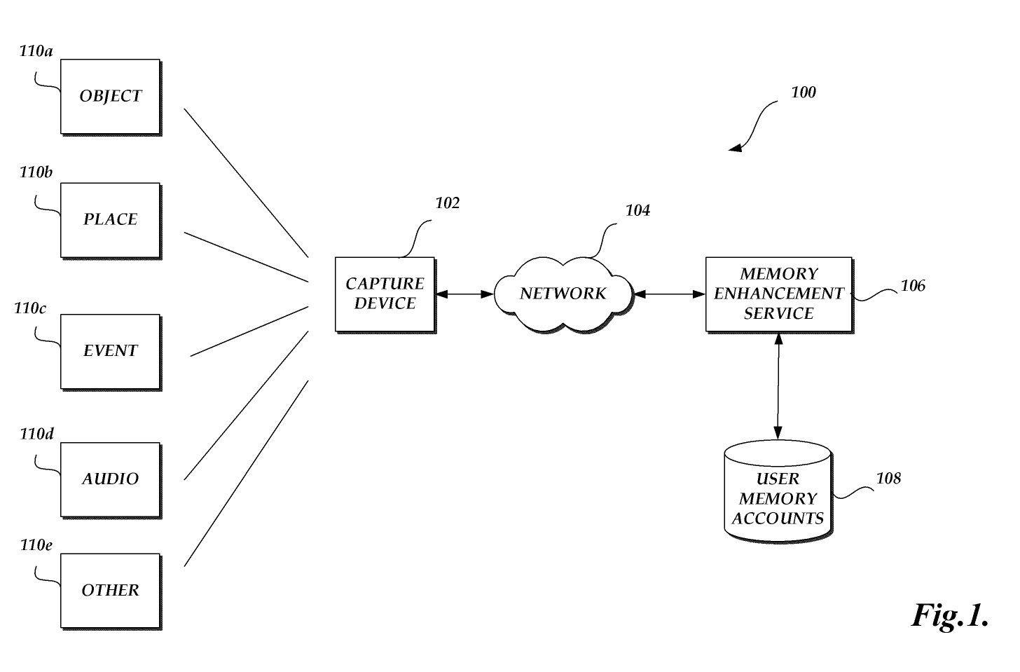

With reference to FIG. 1, an illustrative operating environment 100 is shown including a memory enhancement service 106 for enhancing and storing data regarding an item of interest captured by a capture device 102. The capture device 102 may be any computing device, such as a laptop or tablet computer, personal computer, personal digital assistant (PDA), hybrid PDA/mobile phone, mobile phone, electronic book reader, set-top box, camera, digital media player, and the like. The capture device 102 may also be any of the aforementioned devices capable of receiving or obtaining data regarding an item of interest from another source, such as a digital camera, a remote control, another computing device, a file, etc. In one embodiment, the capture device 102 communicates with the memory enhancement service 106 via a communication network 104, such as the Internet or a communication link. Those skilled in the art will appreciate that the network 104 may be any wired network, wireless network or combination thereof In addition, the network 104 may be a personal area network, local area network, wide area network, cable network, satellite network, cellular telephone network, or combination thereof Protocols and components for communicating via the Internet or any of the other aforementioned types of communication networks are well known to those skilled in the art of computer communications and thus, need not be described in more detail herein.

The memory enhancement service 106 of FIG. 1 may enhance data regarding the item of interest that is captured by the capture device 102 and store it on behalf of the user in a memory account that may be accessed by the user. In one embodiment, such user memory accounts are stored in a user memory account data store 108 accessible by the memory enhancement service 106. The stored data may include any data related to the item of interest captured by the capture device 102, as well as any enhanced data provided by the memory enhancement service 106. In addition and as described in more detail below, the data stored in the user's memory account relating to the item of interest may be further augmented by the user. While the data store 108 is depicted in FIG. 1 as being local to the memory enhancement service 106, those skilled in the art will appreciate that the data store 108 may be remote to the memory enhancement service 106 and/or may be a network-based service itself While the memory enhancement service 106 is depicted in FIG. 1 as implemented by a single component of the operating environment 100, this is illustrative only.

The memory enhancement service 106 may be embodied in a plurality of components, each executing an instance of the memory enhancement service. A server or other computing component implementing the memory enhancement service 106 may include a network interface, memory, processing unit, and computer readable medium drive, all of which may communicate with one another by way of a communication bus. The network interface may provide connectivity over the network 104 and/or other networks or computer systems. The processing unit may communicate to and from memory containing program instructions that the processing unit executes in order to operate the memory enhancement service 106. The memory generally includes RAM, ROM, and/or other persistent and auxiliary memory.

The operating environment 100 depicted in FIG. 1 is illustrated as a computer environment including several computer systems that are interconnected using one or more networks. However, it will be appreciated by those skilled in the art that the operating environment 100 could have fewer or greater components than are illustrated in FIG. 1. In addition, the operating environment 100 could include various web services and/or peer-to-peer network configurations. Thus, the depiction of the operating environment in FIG. 1 should be taken as illustrative and not limiting to the present disclosure.

As noted above, the item of interest to the user may be anything a person can see, hear, imagine, think about or touch. Accordingly, the item of interest may be an object 110a, a place 110b, an event 110c, an audio input 110d (e.g., a voice recording made by the user or a sample of a song), or any other input 110e. Examples of such other input include, but are not limited to, motion input via motion capture technology, text input from the user utilizing the keypad of the capture device 102, a drawing input by the user using a touch screen or stylus of the capture device 102, or a media input from the capture device 102. Accordingly, the data captured regarding the item of interest may be in the form of visual data (e.g., an image, drawing, text, video, etc.), aural data (e.g., a voice recording, song sample, etc.) or tactile data (e.g., motion capture input, touch pad entries, etc.). Moreover, such data may include or be representative of cognitive data (e.g., the user's thoughts, imagination, etc.). The captured data may be submitted to the memory enhancement service 106 as a file or as a file attached to an electronic message, such as an electronic mail message, a short message service (SMS) message, etc., or via any other input mechanism, whether digital or analog.

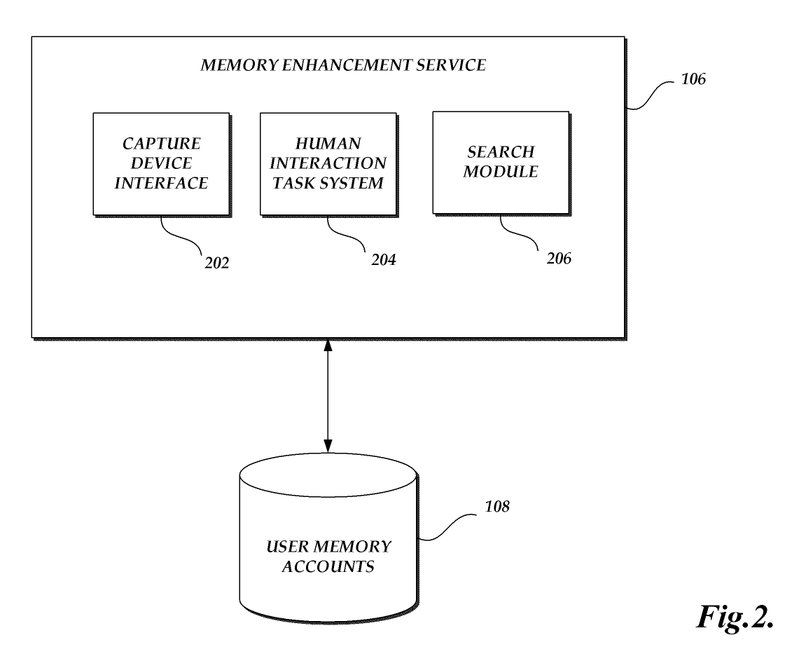

With reference to FIG. 2, illustrative components of the memory enhancement service 106 for use in enhancing and storing captured data such as that described above will now be addressed. In one embodiment, the memory enhancement service 106 includes a capture device interface 202 for receiving captured data from the capture device 102 and submitting the captured data to a human interaction task system 204. In one embodiment, the capture device interface 202 utilizes an application programming interface (API) that generates a human interaction task (HIT) based on the captured data and submits the HIT to the human interaction task system 204 for processing.

Generally described, the human interaction task system 204 makes human interaction tasks or HITs available to one or more human workers for completion. For example, a HIT may be assigned to one or more human workers for completion or the HIT may be published in a manner that allows one or more human workers to view the HITs and select HITs to complete. The one or more human workers may be compensated for completing HITs. For example, a human worker may be compensated for each HIT completed, or each group of HITs completed, for each accepted response to a HIT, in some other manner, or in any combination thereof Additionally, the human workers may be rated based on the number of HITs completed or a measure of the quality of HITs completed, based on some other metric, or any combination thereof

In one embodiment, the HIT generated by the capture device interface 202 requests that a human worker determine what the item of interest is from the captured data and/or determine the user's interest in the item. In addition, the HIT may request that the human worker further enhance the captured data by providing additional information related to the item of interest. A plurality of human workers may complete, and thus, provide responses to the HIT generated by the capture device interface 202. Accordingly, different human workers may reach different determinations regarding the identification of the item and/or the user's interest in the item.

In one embodiment, the memory enhancement service 106 (and/or the human interaction task system 204) aggregates like responses from the various human workers and selects the response occurring with the greatest frequency from the human workers for further processing. Alternatively, the memory enhancement service 106 may cluster or prioritize (e.g., select the most common or highest rated) responses received from the human workers for further processing. In yet another embodiment, the memory enhancement service 106 selects the first response received from the human interaction task system 204 for further processing. Those skilled in the art will appreciate that a variety of techniques may be used to select the HITs to be further processed by the memory enhancement service 106. Thus, the above-mentioned examples are illustrative and should not be construed as limiting.

In yet other embodiments, the user may augment the data captured by the capture device 102 with further information that can be used by the memory enhancement service 106 to identify the item of interest and/or the user's interest in the item. Such augmented or added data may also be considered part of the captured data submitted to the memory enhancement service 106. For example, the user may add one or more keywords to provide additional context for processing the captured data. In one embodiment, the one or more keywords are included in the HIT generated by the capture device interface 202 and submitted to the human interaction task system 204 to provide the human workers with additional context for processing the HIT. In other embodiments, the one or more keywords may be used to generate a search query that is submitted to a search module 206 implemented by the memory enhancement service 106. The search module 206 may then perform a search based on the submitted search query for additional information regarding the item of interest. In this embodiment, the capture device interface 202 may also utilize an API for generating such search queries and submitting them to the search module 206. The search results may be used to further enhance the data regarding the item of interest captured by the capture device 102. For example, the search results may be stored with the results of the HIT in the user's memory account maintained in the data store 108. In other embodiments, the search results may be included in the HIT submitted to the human interaction task system 204. Those skilled in the art will appreciate that the search module 206 may submit search queries to, and obtain search results from, specific data stores available to the memory enhancement service 106. Alternatively, the search module 206 may conduct a general search of network resources accessible via the network 104.

The user's interest in the item subject of the captured data may also include or be dependent upon the user's intent in submitting the captured data to the memory enhancement service 106. Accordingly, in some embodiments (e.g., those in which the captured data is submitted to the human interaction task system 204 without any indication of a purpose for enhancing the captured data), the human interaction task system 204 determines the user's intent in submitting the captured data (e.g., the user's intent regarding how the data related to the item of interest is to be enhanced) as part of determining the user's interest in the identified item. For example, if the user submits a voice recording without any indication of a purpose for enhancing the data, the human interaction task system 204 may determine that the user submitted the voice recording with the intent that the memory enhancement service 106 identify the name of a song rather than the intent that the memory enhancement service 106 transcribe the voice recording. Accordingly, the human interaction task system 204 provides the name of the song, as well as a sample of a previously recorded version of the song. As yet another example, if the user submits a digital image of a coffee mug, the human interaction task system 204 may determine that the user submitted the digital image with the intent to purchase it rather than the intent to find the location of local coffee shops. Accordingly, the human interaction task system 204 provides the name and Universal Product Code (UPC) of the coffee mug and a link to a network-based retail service at which the coffee mug is available for purchase.

Although described above as components of the memory enhancement service 106, the human interaction task system 204 and the search module 206 may be discrete services or components from the memory enhancement service 106. Accordingly, the memory enhancement service 106 may include one or more interface components for communication with the human interaction task system 204 and/or search module 206 via the network 104.

The results of the search query (if conducted) and the result of the HIT submitted to the human interaction task system 204 enhance the data captured by the capture device 102 and submitted to the memory enhancement service 106. Such enhanced data is stored on behalf of the user in a memory account associated with the user and maintained in the data store 108. As will be described in more detail below, the user may subsequently recall the enhanced data from his or her memory account for further review or use. In some embodiments, the user may also share the enhanced data with his or her contacts and/or with other network-based services.

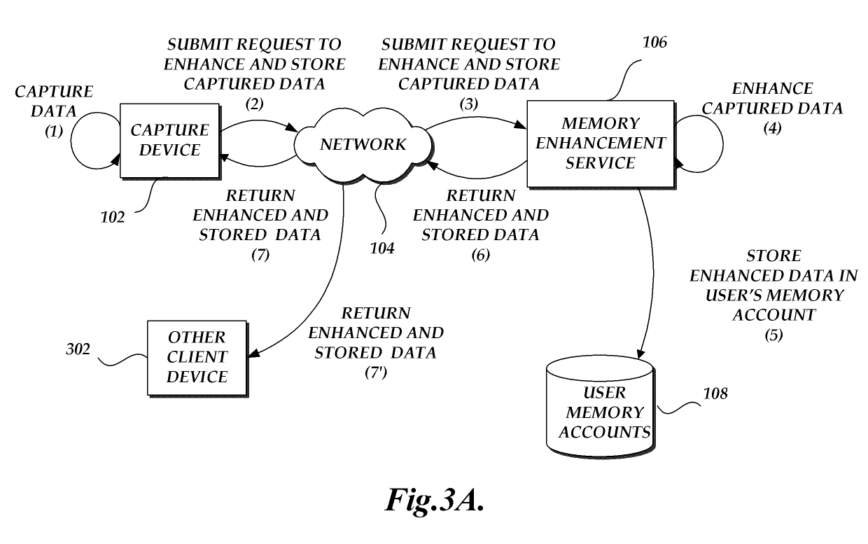

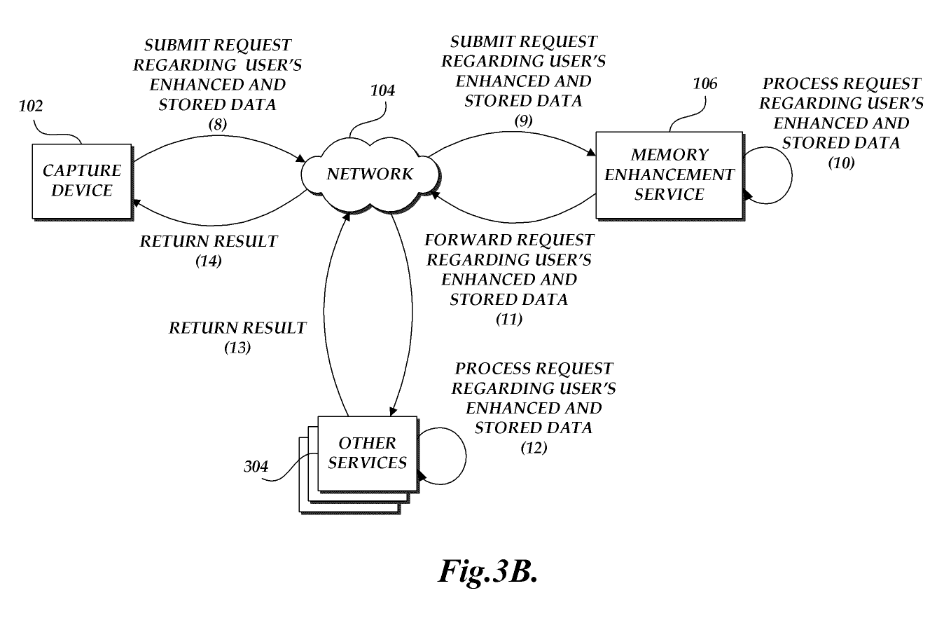

FIG. 3A is a block diagram of a capture device 102 submitting a request to the memory enhancement service 106 to enhance and store captured data on behalf of a user. As depicted in FIG. 3A, the capture device 102 captures data regarding an item of interest to the user. As noted above, the item of interest may be an object 110a, place 110b, event 110c, audio input 110d or other input 110e. The data captured by the capture device 102 may take a variety of forms depending on the item of interest and/or the type of capture device 102. Once captured and perhaps further augmented by the user (e.g., with one or more keywords, a notation, etc.), the capture device 102 submits a request to enhance and store the captured data to the memory enhancement service 106 via the network 104. The memory enhancement service 106 then enhances the captured data prior to storing it in the user's memory account in the data store 108.

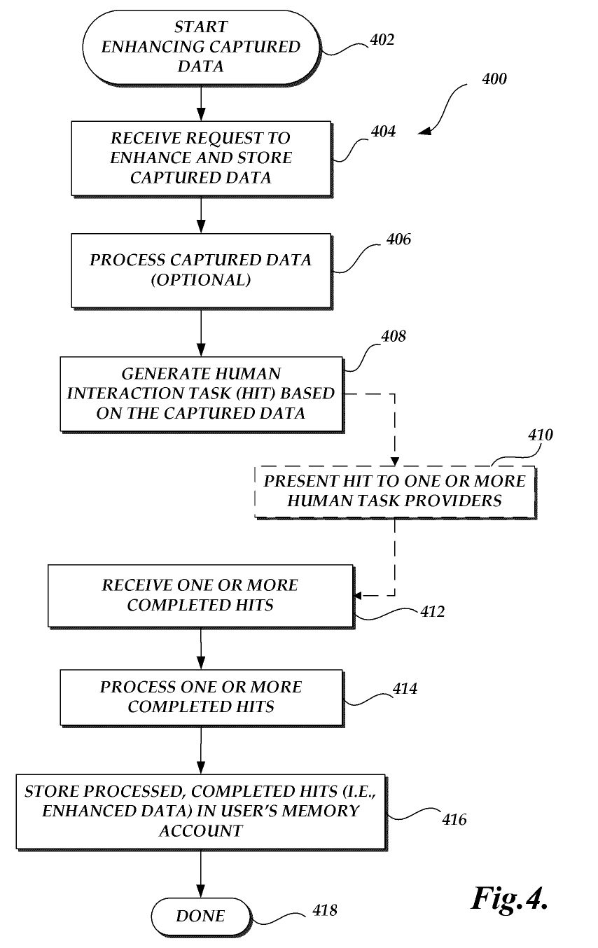

As discussed above, the memory enhancement service 106 may enhance the captured data by submitting a HIT related to the captured data to the human interaction task system 204 and/or by submitting a search query related to the captured data to the search module 206. Such enhancements may reduce or eliminate the need for the user of the capture device 102 to submit or input detailed notes identifying or regarding the item of interest. Moreover, such enhancements may provide the user with additional and perhaps more robust information regarding the item of interest than the user would have otherwise. An illustrative routine for enhancing the captured data is described in more detail below in connection with FIG. 4.

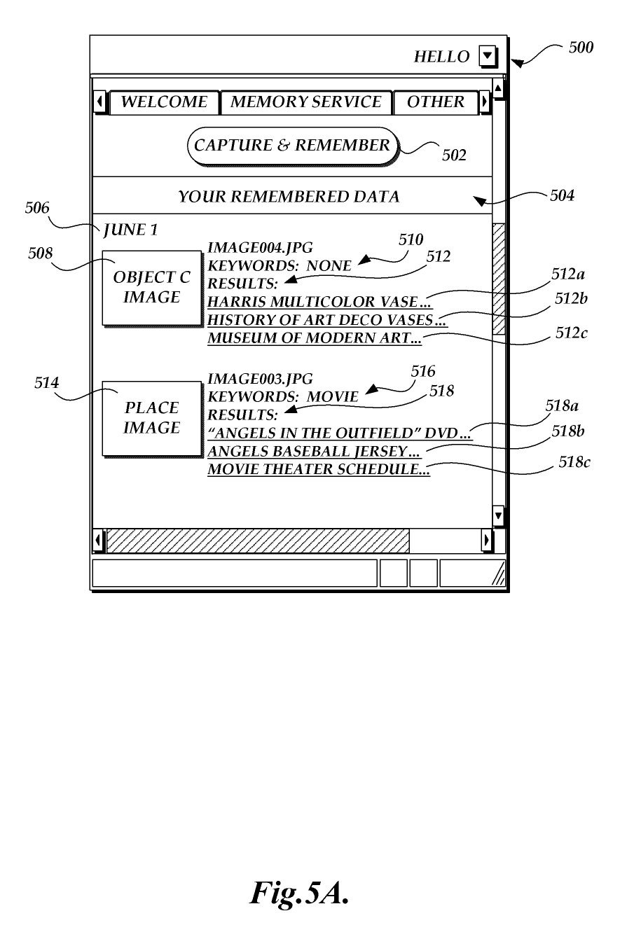

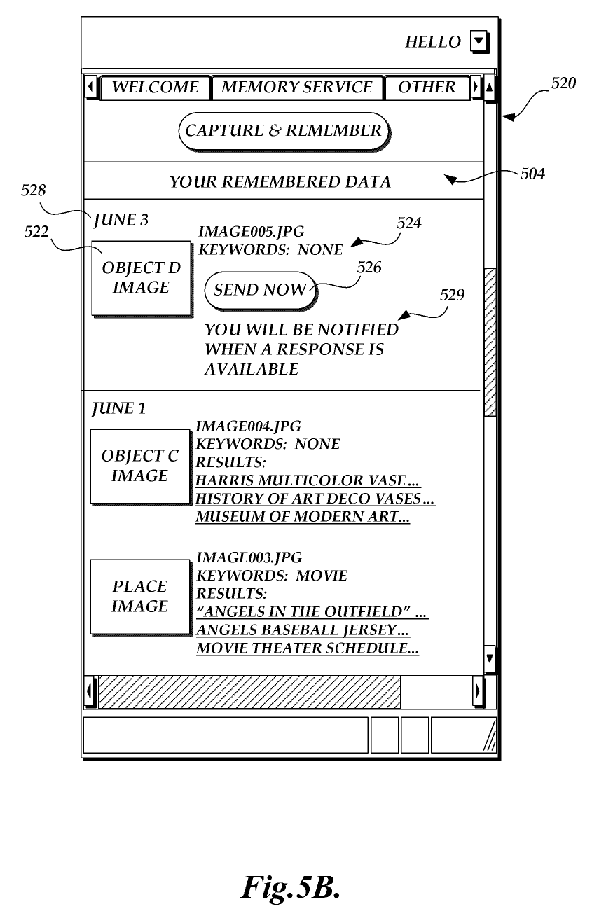

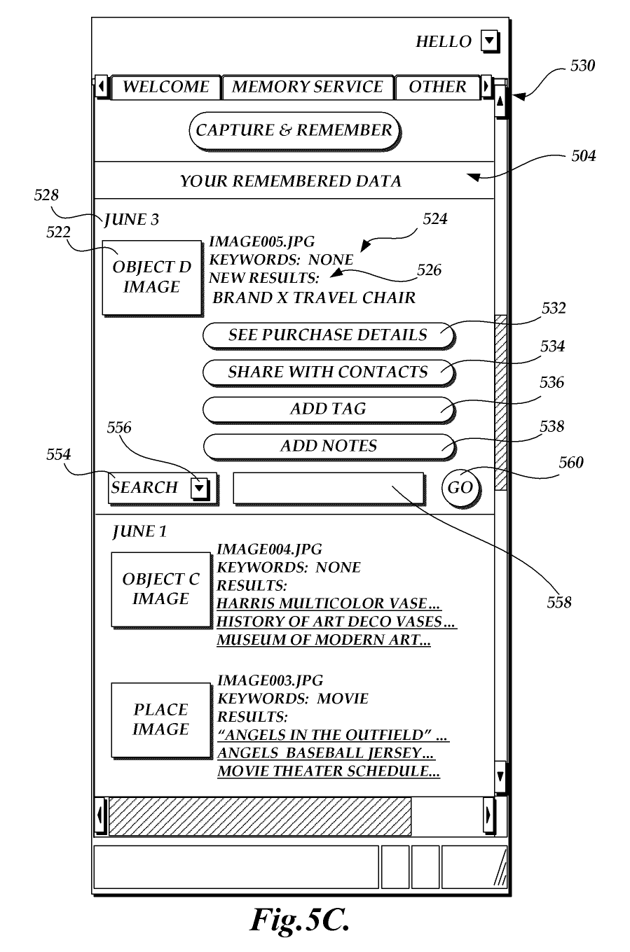

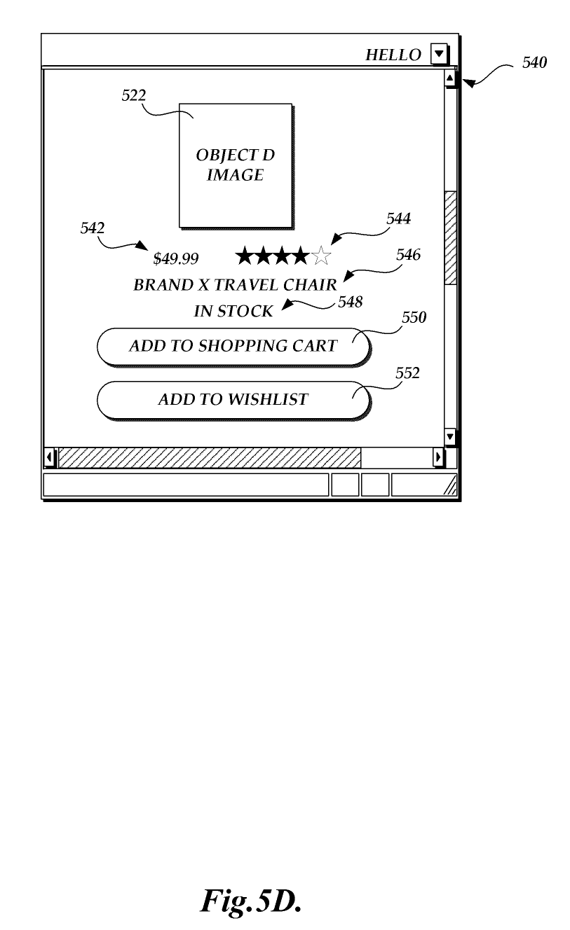

Referring again to FIG. 3A, once enhanced, the memory enhancement service 106 stores the enhanced data in the user's memory account maintained by the data store 108 for future recall by the user. In addition, the memory enhancement service 106 returns the enhanced and stored data via the network 104 to the capture device 102. Returning to a previous example, if the user has submitted a request to enhance and store an audio recording of a portion of a song and the memory enhancement service 106 has enhanced this data by identifying the name of the song recorded, the memory enhancement service 106 will return the name of the song to the capture device 102 of the user. In an alternative embodiment, the memory enhancement service 106 may return the enhanced and stored data (e.g., the name of the song) to another client device 302 specified by the user. Accordingly, the user may configure his or her account with the memory enhancement service 106 to return enhanced and stored data to the user's capture device 102 (e.g., the user's mobile phone) and/or to one or more of the user's other client devices 302 (e.g., the user's home computer). In one embodiment, the enhanced and stored data is returned to the capture device 102 via a user interface generated by the memory enhancement service 106 and displayed on the capture device 102, such as that shown in FIG. 5C, 5D, 7A or 7B, described in more detail below. In yet other embodiments, the enhanced, captured data is returned to the capture device 102 or other client device 302 via an electronic mail message, a SMS message, an electronic message that is published or posted for viewing by others (sometimes known as a “twitter” message or “tweet”), a user interface generated by another network-based service 304 (such as a social network service), etc.

If the user makes a request regarding the user's returned enhanced and stored data, the request may be submitted to the memory enhancement service 106 and processed as shown in FIG. 3B. The request regarding the user's enhanced and stored data may take a variety of forms. For example, and as will be described in more detail below, the user's request may be to see additional purchase details, share the enhanced and stored data, tag the enhanced and stored data, or add a notation to the enhanced and stored data. In yet other examples, the request may be to purchase the item of interest or provide a location and/or directions for the item of interest. In yet other examples, the request may be to sort the user's enhanced and stored data based on various criteria input by the user or selected by the user, search for additional information related to the enhanced and stored data, etc.

Although the request regarding the user's enhanced and stored data is depicted in FIG. 3B as submitted by the capture device 102, those skilled in the art will appreciate that the request may be submitted from another computing device utilized by the user, such as client device 302 shown in FIG. 3A. The request is submitted via the network 104 to the memory enhancement service 106, where it may be further processed. In one embodiment, such processing may include submitting the enhanced and stored data to the human interaction task system 204, in which case the further enhanced data provided by the human interaction task system 204 may be stored in the user's memory account and returned to the capture device 102 or other client device 302. In other embodiments, the memory enhancement service 106 may store the request in the user's memory account for later recall such as in the case where the user has added a notation regarding the enhanced and stored data. In yet other embodiments the memory enhancement service 106 may determine that it is appropriate to forward the request regarding the user's enhanced and stored data to one or more other network-based services 304 for further processing and/or storage in association with the user (e.g., in a wish list, as a recommendation, etc.). For example, if the request regarding the user's enhanced and stored data is for purchasing the item of interest, the memory enhancement service 106 may forward the purchase request to a network-based retail service that offers the item of interest for sale. The purchase request may then be processed by the retail service and the result of such processing (e.g., confirmation of the sale, request for payment data or shipping information, etc.) may be exchanged between the retail service and the capture device 102. Any further actions or information necessary to complete the purchase can then be performed between the capture device and the other retail service as already known in the art.

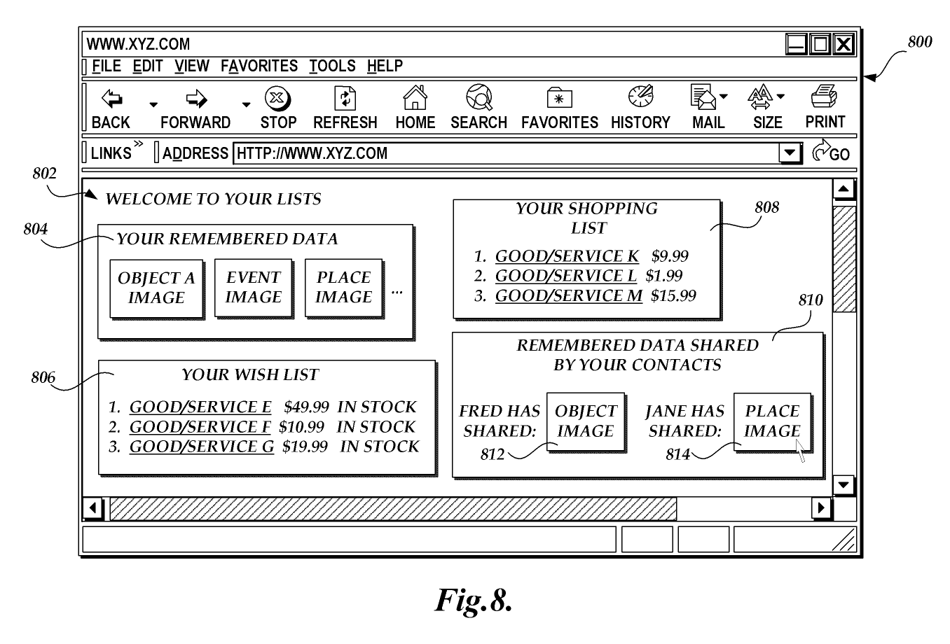

In yet another embodiment, the request regarding the user's enhanced and stored data may be a request to share the user's enhanced and stored data with the user's contacts. In such an embodiment, the memory enhancement service 106 may forward the request to another network-based service 304 such as a social network service (e.g., which may include or support a virtual community, web log (blog), etc.) or message publication service at which the user is known by the memory enhancement service 106 to have an account. Accordingly, the social network service or message publication service may then provide the user's enhanced and stored data with the user's contacts who are also members of such services. The social network service or message publication service may then return confirmation to the user of the capture device 102 that his or her enhanced and stored data has been shared. Such requests to share enhanced and stored data are described in more detail below in connection with FIGS. 8, 9 and 10.

Although the other network-based services 304 are depicted in FIG. 3B as being distinct and remote from the memory enhancement service 106, those skilled in the art will appreciate that one or more of the other network-based services 304 may be local to, part of, operated by, or operated in conjunction with the memory enhancement service 106 without departing from the scope of the present disclosure. In addition, while a retail service, social network service and message publication service are described above as examples of other network-based services 304 to which the enhanced and stored data may be forwarded, these examples are illustrative and should not be construed as limiting.

FIG. 4 is a flow diagram of an illustrative routine 400 implemented by the memory enhancement service 106 to enhance data captured by the capture device 102. The routine begins in block 402 and proceeds to block 404 in which the memory enhancement service 106 obtains a request from the capture device 102 to enhance and store the captured data. As described above, the captured data can take a variety of forms, for example, a digital image, an audio recording, a text file, etc. In addition, the captured data may include one or more keywords or a notation input by the user to provide context for the captured data. In yet other embodiments, the captured data may include an indication of a particular type of search to be conducted related to the captured data. For example, in addition to or in lieu of keywords, the user could input an indication to search for pricing information, availability, reviews, related articles, descriptive information, location, or other information related to the item of interest, or any combination thereof The capture device 102 may also be configured to provide such keywords or other search indications so that the user need not manually input such information.

Upon receipt of the request to enhance and store the captured data, but prior to submitting the captured data to the human interaction task system 204, the captured data may be optionally processed in block 406 in order to provide the human interaction task system 204 with additional information or data that may be useful in identifying the item of interest subject of the captured data, determining the user's interest in the item, providing information related to the item that is likely of interest to the user, etc. For example, a search query associated with the captured data may be submitted to the search module 206. In one embodiment, the search query includes an indication of the type of search to be conducted or one or more keywords that were obtained from the capture device 102 as part of the captured data. Accordingly, the search query may specify any information related to an item of interest. Non-limiting examples of such information include a location of an item of interest, whether an item of interest is available for purchase or shipment via one or more network-based retail services, cost of an item of interest, reviews associated with an item of interest, a best available price for an item of interest, similar items to the item of interest, or any other information related to the item of interest, or any combination thereof Accordingly, in one embodiment, the search results may include a link to a network-based retail service where the object can be purchased or another network resource or service where more information about the item of interest can be found. Upon receipt of the search results generated by the search module 206, the search results may be used to augment the HIT submitted to the human interaction task system 204.

In yet another embodiment, the processing conducted in block 406 may include processing of the captured data with automated algorithms in order to provide the human interaction task system 204 with additional information that may be useful. For example, a digital image captured by the capture device may be subjected to an optical character recognition (OCR) algorithm to identify the item of interest by a UPC appearing on the item of interest shown in the digital image. Those skilled in the art will appreciate that a variety of automated algorithms may be implemented by the memory enhancement service 106 to further process the captured data and provide additional information to the human interaction task system 204 without departing from the scope of the present disclosure. Moreover, in some embodiments, automated algorithms may be used in lieu of the human interaction task system 204 to process the captured data and provide additional information.

In yet other embodiments, the processing conducted in block 406 may include obtaining profile information associated with the user that may be used by the human interaction task system 204 to identify the item of interest, determine the user's intent in sending a request to the memory enhancement service 106, and/or provide additional information regarding the item that may be of interest to the user. For example, the memory enhancement service 106 may maintain a profile for the user that includes demographic data regarding the user (e.g., age, gender, address, etc.), data regarding the user's preferences or interests (e.g., for foods, books, movies, sports teams, hobbies, holidays, etc.), calendar information (e.g., schedule of events, list of birthdays, etc.), contact information (e.g., an address book), etc. In another embodiment, user profile information may be obtained by the memory enhancement service 106 from another network-based service 304 that maintains such information about the user. For example, a network-based retail service may maintain such information about the user, as well as purchase history information, browse history information, etc. Accordingly, such profile information may be provided or made accessible to the human interaction task system 204 for use in generating the enhanced data. For example, the profile information may be used in identifying the item of interest to the user, determining the user's intent in sending a request to the memory enhancement service 106, providing additional information regarding the item that likely is of interest to the user, etc. Moreover, in some embodiments, once the memory enhancement service 106 has enhanced the data related to the item of interest, the service may store the enhanced data in the user's profile so that it may be used by the memory enhancement service 106 or other network-based services 304 for other purposes (e.g., to generate recommendations, to update a wish list, etc.).

In yet another embodiment, the user profile maintained by the memory enhancement service 106 includes a history of requests made by the user to the service. Accordingly, such profile information may assist the human interaction task system 204 in generating the enhanced data. For example, the profile information may be used in identifying the item of interest, determining the user's intent in sending a request to the memory enhancement service 106, providing additional information regarding the item that is likely of interest to the user, etc. Using a previous example, if the user has previously submitted voice recordings to the memory enhancement service 106 for identification and subsequently submits a new voice recording, the human interaction task system 204 may use this historical information to determine that the user again wishes to identify the song subject to the new voice recording. In yet another example, if the user has previously submitted digital images of places and obtained directions thereto from the memory enhancement service 106, the human interaction task system 204 may use this historical information when processing the next image of a place received by the memory enhancement service 106.

In yet other embodiments, the processing conducted in block 406 may include obtaining profile information associated with the capture device that may be used by the human interaction task system 204 to identify the item of interest, determine the user's intent in sending a request to the memory enhancement service 106, and/or provide additional information regarding the item that may be of interest to the user. For example, such profile information may include the physical or geographical location of the capture device (e.g., as provided by a global positioning system (GPS) component of the device, as identified from an Internet Protocol (IP) address, as manually input by the user, etc.). Such profile information may be provided or made accessible to the human interaction task system 204 for use in generating the enhanced data. Using a previous example, the human interaction task system 204 may use the location of the capture device 102 as indicated by its GPS component (or other location identification mechanism, including, but not limited to, manual input) to provide location information for local wine shops which stock a bottle of wine subject to a digital image received by the memory enhancement service 106.

Referring again to FIG. 4, a HIT is generated based on the captured (and perhaps further processed) data in block 408 and presented to one or more human workers by the human interaction task system 204 in block 410. As described above, the human workers process the HIT to identify the item of interest and determine the user's interest in the item. A HIT is a request made available to one or more human workers managed by the human interaction task system 204 that specifies a task to be accomplished. The task may include an action that is more readily accomplished by a human than by a computer. For example, a human viewing a digital image may more readily identify one or more objects, places or events that are depicted. To illustrate, the image may depict a first object in the foreground and multiple other objects in the background. In this situation a computing algorithm may have difficulty separating the first object, which is assumed to be the item of interest, from the other objects. However, a human may readily identify the first object as the object that is of interest to the user. As yet another illustration, the image may depict a person standing in front of a building, such as a movie theater. In this situation, a computing algorithm may have difficulty identifying the building or determining if the person or the building is the item of interest. However, a human may more readily identify the building as a movie theater and thus infer that the user's interest is in the movie theater rather than the person pictured. Accordingly, in response to the HIT, the human worker may identify the movie theater and return the schedule of movies playing at the depicted theater on that given date and/or provide directions to the movie theater depicted in the image. As yet another example, the captured data may include a voice recording of a song made by the user. In this case as well, a human may more readily identify the song recorded by the user and thus, determine that the user is interested in the name of the song. Therefore, in response to the HIT, the human worker may return the name of the song and a link to a network-based retail service where the song can be purchased.

In block 412, the memory enhancement service 106 receives one or more completed HITs from the human interaction task system 204. A completed HIT is one that has been processed by a human worker and includes the enhanced data provided by the human worker, such as the identification of the item of interest and the information related to the item that the human worker believes may be of interest to the user. Since the HIT may be presented to one or more human workers by the human interaction task system 204, one or more responses to the HIT may be received.

In block 414, the one or more completed HITs may be further processed to select the HITs to be stored in the user's memory account, verify that the selected, completed HITs are accurate, obtain additional data regarding the completed HITs, etc. For example, the memory enhancement service 106 may simply select the first received completed HIT for storage in the user's memory account and take no further action. In yet another example, a first received completed HIT may be verified when another completed HIT is received that agrees with the first completed HIT. As yet another example, the memory enhancement service 106 may wait to receive a plurality of completed HITs and aggregate the completed HITs that are common to each other. Accordingly, the completed HIT that occurs with the greatest frequency may be stored in the user's memory account. As a practical example, assume ten completed HITs are received by the memory enhancement service 106. If eight of the ten completed HITs indicate that the item of interest is a movie theater and that the information related to the item that is of interest to the user is the movie theater schedule, the enhanced data from such a completed HIT will be stored by the memory enhancement service 106 in the user's memory account.

In yet another example, a completed HIT is verified if it is determined by the memory enhancement service 106 that the HIT has been completed a threshold number of times. Alternatively, the memory enhancement service 106 compares a completed HIT to similar HITs completed in response to other users' requests to enhance and store captured data. If multiple users are found to be submitting requests regarding the same or substantially similar items of interest and the human interaction task system 204 is generally returning the same or similar enhanced data regarding the item of interest, the memory enhancement service 106 may verify the completed HIT accordingly. Those skilled in the art will recognize that a variety of techniques may be used to select and/or verify completed HITs without departing from the scope of the present disclosure. If the completed HIT is not verified, one skilled in the art will also recognize that the HIT may be resubmitted to the human interaction task system 204 or that a different completed HIT may be selected by the memory enhancement service 106 for storage in the user's memory account.

In yet other embodiments, the completed one or more HITs may be processed to obtain even further information regarding the item of interest that is the subject of the captured data. For example, information obtained from one or more of the completed HITs may be used to generate a search query submitted to the search module 206. The completed HIT may include the name of the item of interest or other identifying information. The identifying information may then be used in a search query submitted to the search module 206. The search results generated by the search module 206 may be stored in the user's memory account along with the information provided by the human interaction task system 204.

Referring again to FIG. 4, once processed, the one or more completed HITs are stored in the user's memory account in block 416. In other words, the information returned by the human worker as part of the completed HIT, as well as any additional information obtained (e.g., from the search module 206), form the enhanced data that is stored on behalf of the user in the user's memory account. The routine then ends in block 418.

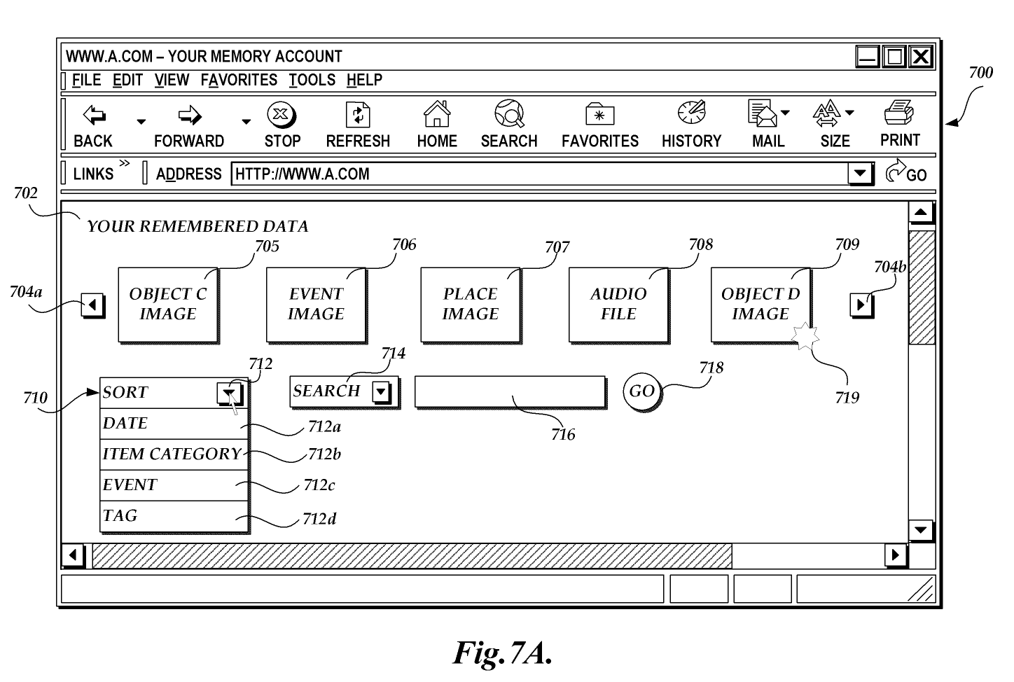

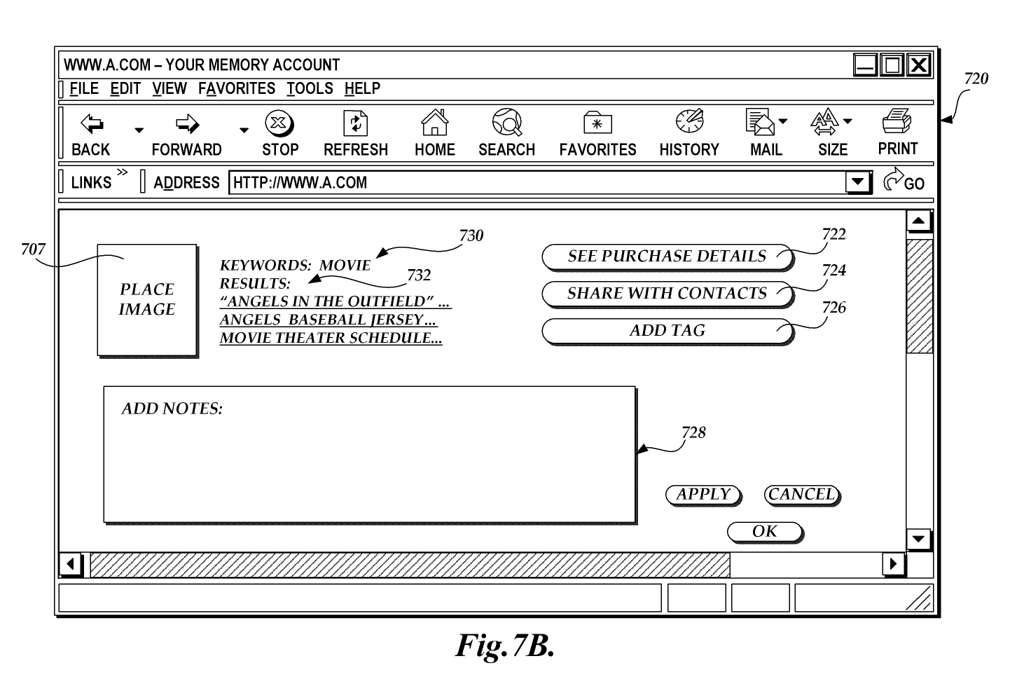

Given that HITs are being processed by a human interaction task system, those skilled in the art will recognize that there may be some delay between submitting the request to enhance and store captured data and storing the enhanced data on behalf of the user in the user's memory account. Accordingly, the memory enhancement service 106 and/or the human interaction task system 204 may notify the user when a response from the memory enhancement service 106 is available. For instance, the user may be notified when the one or more completed HITs are stored in the user's memory account. Such a notification may be sent via an electronic mail message, a SMS message, an electronic message that is published or posted for viewing by others, a user interface generated by another network-based service 304 (such as a social network service), a voice message, etc. In other embodiments, when the user's memory account is later displayed (e.g., as shown in FIG. 7A), a visual indicator (e.g., indicator 719 in FIG. 7A) may be displayed in conjunction with the newly added enhanced data in order to notify the user of any enhanced data added to the user's memory account since the user last accessed the account. If a response to the request to enhance and store data is not received from the memory enhancement service 106 (e.g., within a certain time period), the memory enhancement service 106 may notify the user that no response is available. In such cases (and perhaps even when a response is received), the memory enhancement service 106 may prompt the user to enter additional data (e.g., one or more keywords, an indication of search type, a notation, etc.) to assist the memory enhancement service 106 and/or human interaction task system 204 in processing the captured data.

In yet other embodiments, the memory enhancement service 106 and/or human interaction task system 204 may prompt the user for feedback regarding the enhanced data generated by the memory enhancement service 106. Such feedback may include a rating or other indication of the performance of the memory enhancement service 106. The user's feedback regarding the performance of the memory enhancement service 106 may be based on, for example, the accuracy of the identification of the item of interest from the captured data, the accuracy of the determination of the user's interest in the item, the appropriateness of the enhanced data provided regarding the item, and/or the timeliness of the response received from the memory enhancement service. Such feedback may also be used to assist the memory enhancement service 106 and/or human interaction task system 204 in processing captured data.

In one embodiment, one or more user interfaces are generated by the memory enhancement service 106 and displayed on the capture device for enabling a user to view enhanced data previously stored by the memory enhancement service 106, capture data regarding additional items of interest and submit a request to enhance and store such captured data to the memory enhancement service 106. An example of a user interface 500 enabling a user to view previously enhanced and stored data is depicted in FIG. 5A. The user interface 500 includes a list 504 of the user's previously “remembered” data, i.e., the data captured regarding items of interest that the user has previously submitted to the memory enhancement service 106 and that has been enhanced and stored in the user's memory account. In the illustrated example, the user's most recently enhanced and stored data (as indicated by a date 506) is displayed first and additional data may be viewed by manipulating a scroll control 505 or like user interface control. However, those skilled in the art will appreciate that the enhanced and stored data may be sorted and displayed in another order or manner without departing from the present disclosure.

In the illustrated example, the list 504 includes an image 508 of an object C that was previously enhanced and stored on behalf of the user in his or her memory account. The image 508 of object C was processed by the memory enhancement service 106, which yielded enhanced data regarding the item of interest, i.e., results 512. In the illustrated example, the memory enhancement service 106 has identified object C subject to the image as a “Harris Multicolor Vase.” Accordingly, a link 512a to additional information regarding the Harris Multicolor Vase is displayed in the user interface 500. In addition to identifying object C as the Harris Multicolor Vase, the memory enhancement service 106 has determined that the user is also interested in a history of art deco vases since the Harris Multicolor Vase is a well-known art deco vase. Accordingly, the memory enhancement service 106 provides a link 512b to an article entitled the “History of Art Deco Vases.” Similarly, since the Harris Multicolor Vase is on display at the Museum of Modern Art, the memory enhancement service 106 has also determined that the user is interested in a current exhibition at the Museum of Modern Art and provides a link 512c to a network resource (e.g., a web site) associated with the Museum of Modern Art. Accordingly, if the user is interested in viewing the enhanced and stored data provided by the memory enhancement service 106, the user may select any of the links 512a, 512b or 512c associated with the image 508 of object C and retrieve the information associated therewith.

The list 504 may also include an image 514 of a place in which the user is interested. In the illustrated example, assume that the user submitted a keyword 516 “movie” in conjunction with the image 514 when submitting the request to enhance and store the image 514 to the memory enhancement service 106. Accordingly, the memory enhancement service 106 has processed the keyword and image 514 and identified the place subject of the image as Angel Stadium in which the Los Angeles Angels of Anaheim are located. Using the keyword 516 “movie” as context, the memory enhancement service 106 has determined that the user is interested in the movie entitled “Angels in the Outfield” and thus, provides a link 518a to the DVD for the movie “Angels in the Outfield” that is available for purchase from a network-based retail service. In the illustrated example, the memory enhancement service 106 has also determined that the user is interested in purchasing an Angels baseball jersey as seen in the movie “Angels in the Outfield” and thus, has provided a link 518b to a network-based retail service offering such an Angels baseball jersey for sale. In addition, the memory enhancement service 106 has determined that the user is interested in a movie theater schedule for movie theaters in proximity to Angel Stadium and thus, has provided a link 518c to such a movie theater schedule.

Although only a few examples of enhanced and stored data are illustrated in the figures and described herein, those skilled in the art will appreciate that a wide number and variety of enhanced data may be generated by the memory enhancement service 106 and provided to the user. Using the image of Angel Stadium as described above, the memory enhancement service 106 could also provide a discount coupon to purchase the DVD for “Angels in the Outfield,” a short clip or trailer from the DVD, etc. In yet another example, if the item of interest is determined by the memory enhancement service 106 to be a book, the memory enhancement service may provide a sample of or excerpt from the book (e.g., a sample chapter of the book, a page of the book including one or more of the keywords submitted with the captured data, etc.).

In the illustrated example, the user interface 500 also includes a user interface control 502 that enables a user to capture data regarding another item of interest and “remember” (i.e., enhance and store) the captured data in the user's memory account. For example, if the capture device 102 upon which the user interface 500 is generated and displayed is a mobile phone including camera functionality, the user may initiate the user interface control 502 to enable the camera functionality of the mobile phone and capture a digital image of another item of interest to the user. Once captured, the image may be displayed to the user via a user interface 520 such as that shown in FIG. 5B.

For example, user interface 520 may include the image 522 of another object, object D, as well as a date 528 associated with the image capture. The user may input additional keywords 524 using any data entry or input device. However, in the illustrated example, the user has not entered any keywords. The user may then submit a request to enhance and store the captured data to memory enhancement service 106 by selecting a “send” user interface control 526. As described above, the request to enhance and store the captured data, i.e., the object D image 522 and the keywords 524, are submitted to the memory enhancement service 106 via the network 104. The memory enhancement service 106 then enhances the captured data prior to storing it in the user's memory account. Those skilled in the art will appreciate that there may be some delay in processing the request to enhance and stored the captured data. Accordingly, a message 529 may be displayed notifying the user that he or she “will be notified when a response (from the memory enhancement service) is available.” As described above, such a notification may also be sent via an electronic mail message, a SMS message, an electronic message that is published or posted for viewing by others, a user interface generated by another network-based service 304 (such as a social network service), a voice message, etc.

As also discussed above, the memory enhancement service 106 may enhance the captured data by submitting a HIT related to the captured data to the human interaction task system 204 and/or by submitting a search query related to the captured data to the search module 206. Such enhancements may reduce or eliminate the need for the user of the capture device 102 to submit or input detailed notes identifying or regarding the item of interest. Moreover, such enhancements may provide the user with additional and perhaps more robust information regarding the item of interest than the user would have otherwise. As noted above, when such enhancements become available, the memory enhancement service 106 (and/or the human interaction task system 204) may notify the user (e.g., via an electronic mail message, a user interface, etc.)

The enhanced and stored data may be displayed to the user via a user interface generated on the capture device 102. Such a user interface 530 is depicted in FIG. 5C. In the illustrated example, the enhanced and stored data is displayed in the user's list 504 of remembered data. Accordingly, the image 522 of object D is displayed along with the date 528 that the image was captured. In one embodiment, the image 522 is the captured image submitted by the capture device 102. However, in other embodiments, the image of the item of interest returned by the memory enhancement service 106 is a different image of the item that is retrieved, or otherwise obtained, by the memory enhancement service 106. For example, if the item of interest is available for purchase from a network-based retail service, the image returned by the memory enhancement service 106 may be the image for the item used by the retail service.

In addition to the image 522 of the object D, any keywords 524 submitted with the captured data are also displayed. In one example and as shown in FIG. 5C, there are no additional keywords. The enhanced and stored data provided by the memory enhancement service 106 are displayed as new results 526. In the illustrated example, the memory enhancement service 106 has identified the object that is the subject of image 522 as the “Brand X Travel Chair” and has determined that the user is interested in purchasing the chair. Accordingly, the memory enhancement service 106 provides the user with a user interface control 532, which if selected by the user, causes retrieval of purchase details for the Brand X Travel Chair available from a network-based retail service.

A user interface control 534 may also be provided that enables the user to share the item of interest and/or at least some of the enhanced and stored data provided by the memory enhancement service 106 with his or her contacts. In one embodiment, if the user interface control 534 is selected, the enhanced and stored data for the item of interest is submitted to the memory enhancement service 106, which then forwards the enhanced and stored data to another network-based service 304, such as a social network service. In this embodiment, the social network service provides the user's enhanced and stored data to the user's contacts (e.g., other users of the social network that are in one or more of the user's social graphs) also registered with the social network service or to other users. In another embodiment, the user may have contacts that also have memory accounts maintained by the memory enhancement service 106. In such embodiments, the memory enhancement service 106 may forward the enhanced and stored data to the user's contacts directly as will be described in more detail below in connection with FIGS. 8, 9 and 10. It will be appreciated by those skilled in the art, that the enhanced and stored data shared by the user may take a variety of forms in different embodiments. For example, in one embodiment, the enhanced and stored data may be shared with the user's contacts in the form of a recommendation to purchase the item of interest. Accordingly, when presented to the user's contacts, the contacts may also be provided with an option to purchase the item of interest. In another embodiment, if the contact purchases the item of interest, the user who shared the enhanced and stored data with the contact may be compensated monetarily, with a discount, with additional goods and services, with redeemable points, with organizational or hierarchical credits (e.g., a “gold level member”), etc., by the network-based retail service that provides the item of interest and/or by the memory enhancement service 106.

In yet another embodiment, the user may select a user interface control 536 for adding a tag, such as a non-hierarchical keyword or term, to the enhanced and stored data that can subsequently be utilized by the user and/or the user's contacts for browsing and/or searching. In yet another embodiment, a user interface control 538 may be provided to enable the user to add a notation to the enhanced and stored data. The notation may be stored in the user's memory account as part of the enhanced and stored data, and also shared with the user's contacts.

In yet another embodiment, the user may select a search option 554 to search for additional items or information similar or related to the item of interest. For example, the user may select a category of items or information in which he or she wishes to search from a drop-down menu (not shown) displayed in response to selecting a menu user interface control 556. Such categories may include, but are not limited to, books, toys, music, etc. The user may then input a keyword for the search in a field 558 and initiate the search by selecting a “Go” user interface control 560. The search initiated by the user may be performed by the search module 206 of the memory enhancement service 106, or may be forwarded by the memory enhancement service 106 to the network-based retail service or to another network-based service 304 for processing.

In the illustrated embodiment, assume the request made by the user regarding the enhanced and stored data is a request to see purchase details for the item of interest (which request is initiated, for instance, by selecting the user interface control 532 depicted in FIG. 5C). Accordingly, the memory enhancement service 106 may generate a user interface 540 such as that shown in FIG. 5D, which may be displayed on the capture device 102 or another client device 302. The user interface 540 may include the image 522 of the item of interest (i.e., object D), as well as additional purchase details regarding the object that are available from a network-based retail service. For example, the purchase details may include a price 542, a rating 544, a description 546, and an indication 548 of available inventory for the item of interest. Those skilled in the art will recognize that the purchase details depicted in FIG. 5D are illustrative and that additional or different purchase details may be included in the user interface 540. Should the user wish to purchase the item of interest, the user may select a user interface control 550 (e.g., for adding the item to his or her shopping cart with the retail service) and enter into a purchase protocol with the retail service. Such purchase protocols are known in the art and therefore, need not be described in more detail herein. In the illustrated embodiment, the user may alternatively select a user interface control 552 to add the item of interest to the user's wish list, for instance, a list of items that the user would like to acquire. In some embodiments the user may have one or more wish lists that are maintained by the network-based retail service offering the item of interest, the memory enhancement service 106 and/or another network-based service 304. Accordingly, if the user selects the add to wish list user interface control 552, the item of interest can also be added to such wish lists.

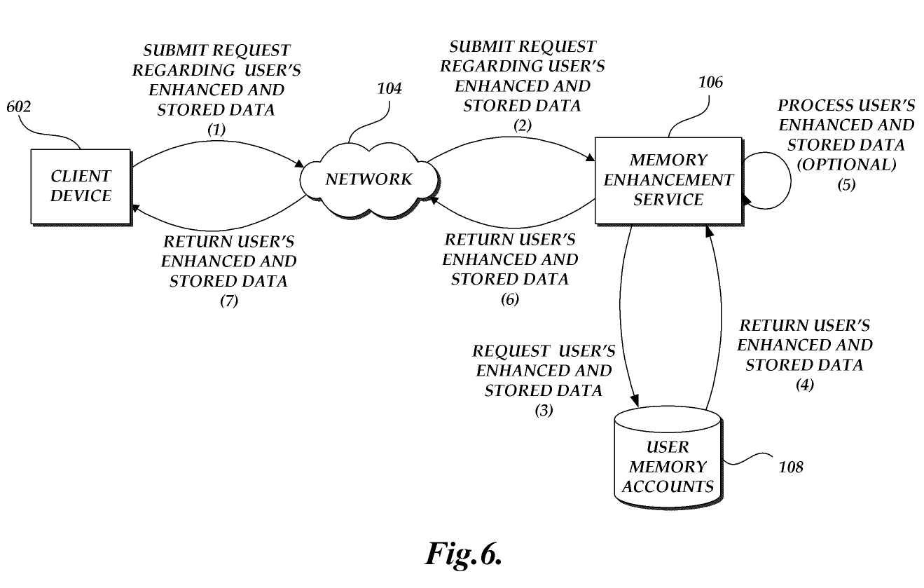

Now that the capture and submission of data related to an item of interest, and the enhancement of such data by the memory enhancement service 106 has been described, further aspects of the present disclosure related to recalling the enhanced and stored data for further reference or use will be described. For example, the user may access the memory enhancement service 106 and recall the enhanced and stored data stored in his or her memory account. In this regard, FIG. 6 is a block diagram of a client device 602 (which may or may not be the same as the capture device 102) submitting a request regarding the user's enhanced and stored data to the memory enhancement service 106. For example, a request by the user to access his or her memory account may be considered a request regarding the user's enhanced and stored data that is submitted to the memory enhancement service 106 from the client device 602 via the network 104. The memory enhancement service 106 may process the user's request regarding the enhanced and stored data and return the enhanced and stored data found in the user's memory account to the client device 602 via the network 104 for display. In some embodiments, the memory enhancement service 106 caches returned results so that if the user re-submits a request, or another user submits a similar request, the memory enhancement service 106 may obtain the enhanced and stored data from a cache instead of submitting a HIT to the human interaction task system 204. Examples of user interfaces for displaying returned enhanced and stored data are the user interface 500 shown in FIG. 5A described above and a user interface 700 shown in FIG. 7A.

In the example illustrated in FIG. 7A, the user interface 700 includes a list 702 of the user's previously “remembered” data, i.e., the data captured regarding items of interest that the user has previously submitted to the memory enhancement service 106 and that has been enhanced and stored in the user's memory account. In one embodiment, the enhanced and stored data (or icons, images, or the like representing the enhanced and stored data) are displayed to the user. In the illustrated example, the user has submitted to the memory enhancement service 106, and the memory enhancement service 106 has stored on behalf of the user, an image 705 of an object C, an image 706 of an event, an image 707 of a place, an audio file 708, and an image 709 of an object D. The user may browse the list 702 by selecting a scroll user interface control 704a or 704b. In addition, the user may further sort his or her list of enhanced and stored data by selecting a sort user interface control 710. More specifically, the user may select one or more criteria by which to sort his or her list of enhanced and stored data from a drop-down menu displayed upon selection of a user interface control 712. Accordingly, in the illustrated example, the list 702 can be sorted by date 712a, item category 712b, event 712c and tag 712d. Those skilled in the art will appreciate that such criteria are illustrative only and that the user interface 700 generated by the memory enhancement service 106 may be configured to provide additional and/or different criteria by which to sort the enhanced and stored data. In other embodiments, the user may organize the enhanced data into different categories or groups similar to a sub-folder or sub-directory structure, so that the user may more easily navigate his or her list of enhanced data and retrieve desired items.

In yet another embodiment, the user may search for particular data in his or her list 702 by selecting a search user interface control 714, entering one or more keywords in a field 716 and selecting a “Go” user interface control 718. Accordingly, any enhanced and stored data stored in the user's memory account that match the keywords entered by the user may be retrieved from the memory enhancement service 106 and displayed to the user.

In yet another example, the user may request additional information regarding enhanced and stored data by selecting an item from the user interface 700. In the illustrated example, the user has selected the image 707 of a place. Accordingly, a user interface 720 such as that depicted in FIG. 7B may be generated and displayed on the client device 602. User interface 720 may include the place image 707, as well as other enhanced data stored with the place image 707 in the user's memory account. Such enhanced and stored data may include keyword(s) 730 previously input by the user, as well as results 732 received from the human interaction task system 204 of the memory enhancement service 106 that processed the HIT for the place image 707. In the illustrated embodiment, the user is also presented with options similar to those previously described. Specifically, the user interface 720 includes a see purchase details user interface control 722, a share with contacts user interface control 724 and an add tag user interface control 726). In the illustrated embodiment, the user interface 720 also includes a field 728 in which the user may add notes regarding the item of interest that may be added to the user's memory account and/or shared with the user's contacts. Should the user select any of these options or make some other request regarding the item of interest, such request may be processed as described above in connection with FIGS. 3B, 5C and 5D.

In another embodiment, the memory enhancement service 106 is also operated in association with other network-based services 304 as described above. In such an embodiment, the user may access his or her user memory account, as well as other information provided or maintained by such other network-based services 304, via a user interface generated by the memory enhancement service 106 or generated by one of the other network-based services 304. An example of such a user interface 800 is depicted in FIG. 8. In the embodiment depicted in FIG. 8, the user interface 800 includes a number of lists or groups of data maintained by the memory enhancement service 106 or other network-based services 304 under a heading “Welcome to Your Lists” 802. Such illustrative lists include a list 804 of the user's “remembered” (i.e., enhanced and stored) data as obtained from his or her memory account, a wish list 806 as maintained by another network-based service 304 such as a network-based retail service, and a shopping list 808 as maintained by the retail service, the memory enhancement service 106 or another network-based service 304. Similar to the example described above with reference to FIGS. 7A and 7B, the user may recall additional data from his or her user memory account by selecting enhanced and stored data from the list 804. Accordingly, a request to retrieve additional information regarding the user's enhanced and stored data will be submitted to the memory enhancement service 106 via the network 104 as shown in FIG. 6; processed by the memory enhancement service 106, if appropriate; requested from the user's memory account in the data store 108; and returned to the user's client device 602. Such additional data may then be displayed to the user via a user interface such as that shown in FIG. 7B.

In another embodiment, the user may re-submit captured data regarding an item of interest to the memory enhancement service 106 in order to recall the enhanced and stored data regarding the item of interest. For example, the user may re-submit a previously captured digital image of the item of interest (or a new digital image of the item of interest) to the memory enhancement service 106. The memory enhancement service 106 may then compare the digital image of the item of interest to the enhanced and stored data in the user's memory account and return the matching data to the user's client device 602. Such additional data may then be displayed to the user via a user interface such as that shown in FIG. 7B.

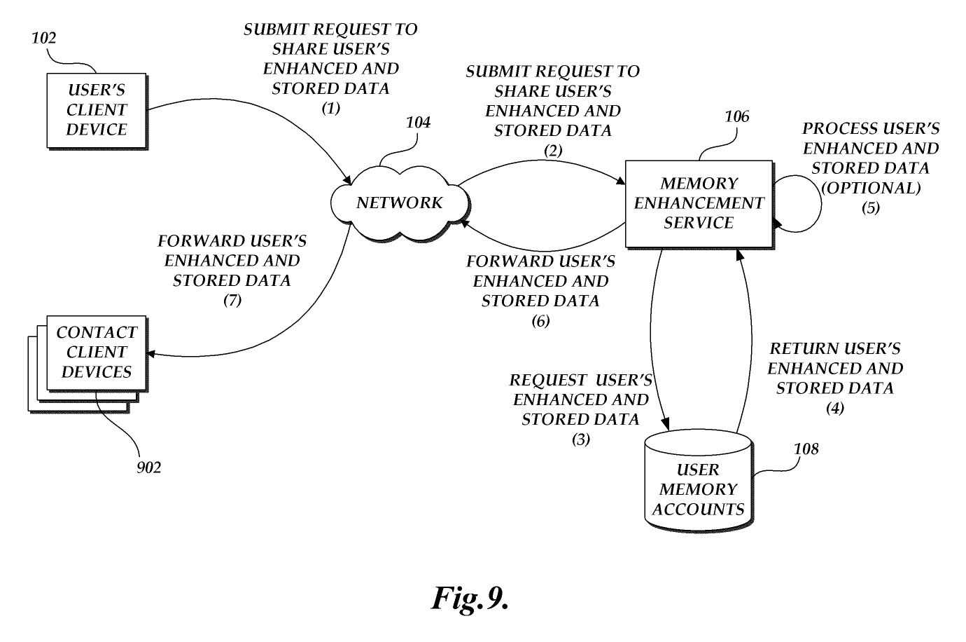

As mentioned above, a user of the memory enhancement service 106 may also share enhanced and stored data with contacts having memory accounts maintained by the memory enhancement service 106 or with contacts that have accounts with other social network services or message publication services in communication with the memory enhancement service 106. With reference to FIG. 9, a user may submit a request to share his or her enhanced and stored data from a client device 602 via the network 104 to the memory enhancement service 106. The memory enhancement service 106 may process the user's enhanced and stored data, if appropriate, by adding a notation input by the user to the enhanced and stored data stored in the user's memory account. The memory enhancement service 106 may then obtain the enhanced and stored data subject to the user's share request from the user's memory account maintained by the data store 108 and forward it to the client devices 902 of the user's contacts via the network 104, either directly or via another service such as a social network service or a message publication service.

In one embodiment, the shared enhanced and stored data is forwarded in the form of a text message, electronic mail message, etc. In yet another embodiment, the user's shared, enhanced and stored data is stored on behalf of the user's contact in the contact's user memory account. Accordingly, when that contact accesses his or her memory account (e.g., via user interface 800 depicted in FIG. 8), the contact may be presented with the user's shared enhanced and stored data.

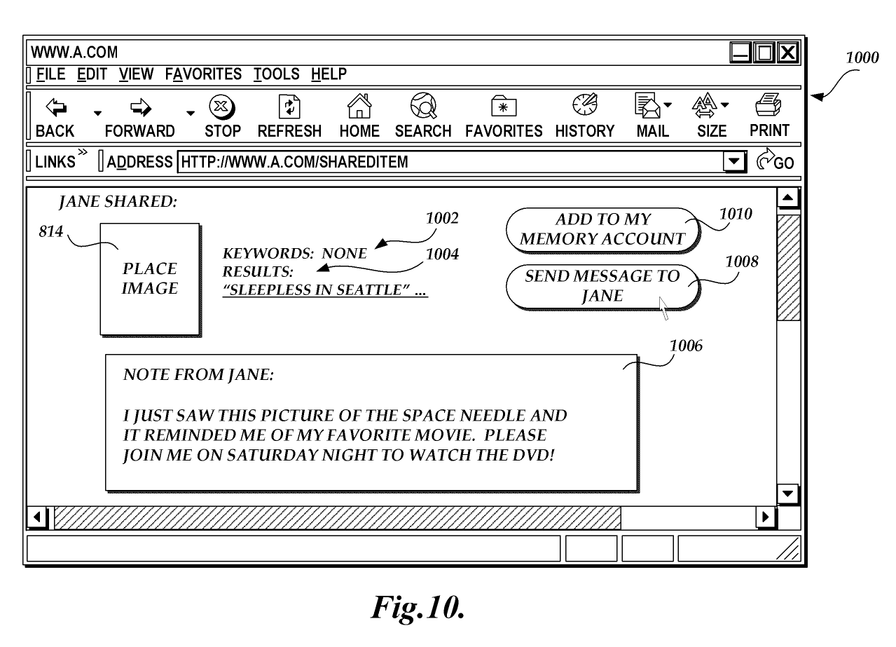

Returning to FIG. 8, the user interface 800 may include a list or group of “remembered” (i.e., enhanced and stored) data 810 that the user's contacts have shared with the user. In the example illustrated in FIG. 8, the user's contacts have shared enhanced and stored data with the user in the manner described above in connection with FIG. 9. Accordingly, a list 810 of such data shared with the user by his or her contacts is displayed. If the user wishes to recall additional information regarding any of the shared enhanced and stored data, the user may select the enhanced and stored data he or she wishes to view in more detail. In the illustrated embodiment, the user selects the enhanced and stored data that Jane has shared by selecting place image 814. In response, the memory enhancement service 106 may generate a user interface 1000 such as that shown in FIG. 10.

As illustrated in FIG. 10, the place image 814 that the contact shared is displayed along with the keyword(s) 1002 submitted with the place image 814. In addition, the results 1004 that were provided by the human interaction task system 204 when processing the HIT for the place image 814 are also displayed. In the illustrated example, a link or other access mechanism to the results provided by the human interaction task system 204 is displayed. However, those skilled in the art will appreciate that the results themselves, or a summary thereof, may be displayed and that the results and/or keywords may be displayed in user interface 1000 or any of the other user interfaces described herein in any manner deemed suitable. Finally, the notation 1006 that was entered by the contact upon requesting to share this enhanced and stored data with the contact is also displayed.

In the illustrated example, assume the image 814 is of the Space Needle in Seattle, Wash. The results 1004 returned by the human interaction task system 204 include the title of the movie “Sleepless in Seattle” and the notation 1006 from the contact invites the user to watch the movie with her. The user may respond to the contact and accept the contact's invitation, by selecting a user interface control 1008 to send a message to the contact. Although not shown, selecting such a user interface control may cause yet another user interface to be displayed in which the user may enter or select contact information for sending the message and/or the body of the message. Those skilled in the art will appreciate that such a message may be delivered to the contact via a text message, an electronic mail message, a voice message, etc., or via another user interface such as that shown in FIG. 8 without departing from the scope of the present disclosure.

As also illustrated in FIG. 10, the user may add the enhanced and stored data shared by his or her contact to the user's own memory account by selecting a user interface control 1010. Once added, the user may recall the shared enhanced and stored data from his or her memory account at any time. Although not shown, selecting such a user interface control may cause yet another user interface to be displayed in which the user may add a tag to the enhanced and stored data, add an annotation to the enhanced and stored data, initiate a search for related information, share the enhanced and stored data with others, etc., as described above. In other embodiments, the user's memory account may be configured to automatically accept enhanced and stored data shared by others. For example, all enhanced and stored data shared by others may be automatically accepted. Alternatively, only enhanced and stored data shared by certain contacts or related to certain items of interest may be automatically accepted. In some embodiments, the user interface may be configured to give the user the option to reject or delete such shared data.

It will be appreciated from the above description that a user may add enhanced data regarding an item of interest to his or her memory account, either directly or via his or her contacts. Accordingly, the user may utilize the memory enhancement service 106 to continuously enhance what the user has “remembered,” i.e., stored in his or her memory account, regarding any particular item of interest to the user. Using a previous example, the user may initially capture an image of an object such as a bottle of wine and submit the captured image to the memory enhancement service 106. The memory enhancement service 106 identifies the item of interest from the captured image as a particular bottle of wine, obtains the rating for the subject bottle of wine and stores this enhanced data (e.g., the image of the bottle of wine, the name and the rating) in the user's memory account. Over time, the user may capture other data related to the bottle of wine, such as a digital image of a wine shop, and submit such captured data to the memory enhancement service as well. As a result, the human interaction task system 204 may determine that the user is interested in local wine shops which stock the bottle of wine and thus, may return location information for such wine shops to the memory enhancement service 106. The memory enhancement service 106 may also store this enhanced data in the user's memory account. After recommending the bottle of wine to a contact, the user's contact may share with the user an image of the vineyard that produced the bottle of wine (e.g., as described above in connection with FIGS. 8, 9 and 10), which shared image the user may add to his or her memory account, and so on.

In yet other embodiments, a user may make all or a portion of his or her memory account available to other users and/or network-based services. Such other users may include the user's contacts or any other user to which the user grants access according to one or more access rules configurable by the user. For example, a user may grant access to all or a subset of his or her contacts. A contact may then view the enhanced data (e.g., via a user interface similar to that shown in FIG. 7A that is generated by the memory enhancement service 106) and select enhanced data regarding one or more items of interest from the user's memory account for addition to the contact's memory account. Accordingly, the contact may recall the selected enhanced and stored data from his or her own memory account at any time and further add enhanced data regarding the item of interest to his or her own memory account. In another embodiment, the user may grant access to the general public. As a result, any other user may view and select the enhanced data stored in the original user's memory account.

In yet another embodiment, multiple users can be associated with a single memory account maintained by the memory enhancement service 106. Accordingly, requests to enhance and store data can be submitted by multiple users, and the enhancements can be stored by the memory enhancement service 106 in a centralized memory account. In this way, the centralized memory account may serve as a community or tribal memory for a group of users. Access, additions, deletions and modifications to the centralized memory account may be made by the users of the group and may be governed by one or more rules configurable by one or more of the users of the group. As is the case above, all or a portion of the centralized memory account may be made available to users outside of the group and/or other network-based services.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for enhancing and storing data related to items of interest to a user, the system comprising:
an interface for obtaining captured data regarding at least one item of interest to the user;
a data store that maintains a memory account for the user; and
a computing device in communication with the data store, the computing device operative to:
receive a request to enhance the captured data;
submit the captured data to a human interaction task system to generate enhanced data related to the at least one item of interest, the human interaction task system generating the enhanced data related to the item of interest by identifying the item of interest that is subject of the captured data, determining the user's interest in the item that is subject of the captured data and providing data regarding the item that is subject of the captured data based on the determined interest; and
store the enhanced data related to the at least one item of interest in the memory account for the user maintained in the data store.

2. The system of claim 1, wherein the request is received without an indication of a purpose for enhancing the captured data.

3. The system of claim 1, wherein the enhanced data includes the captured data.

4. The system of claim 1, wherein at least one of the request and the captured data further comprises one or more keywords providing context for the captured data.

5. The system of claim 1, wherein at least one of the request and the captured data further comprises a notation providing context for the captured data.

6. The system of claim 1, wherein the computing device is operative to provide enhanced data stored in the memory account for the user to a computing device.

7. The system of claim 1, wherein the computing device is operative to provide enhanced data stored in the memory account for the user to a computing device utilized by a different user.

8. The system of claim 1, wherein the computing device is operative to provide enhanced data stored in the memory account for the user to a network-based service.

9. The system of claim 1, wherein the captured data comprises at least one of visual data, aural data, cognitive data and tactile data.

10. A method for enhancing and storing data related to at least one item of interest to a user, the method comprising:
obtaining a request from the user, wherein the request includes data related to at least one item of interest to the user;
submitting the data related to the at least one item of interest to a human interaction task system to generate enhanced data related to the at least one item of interest, the enhanced data comprising an identification of the item of interest and data that is determined by the human interaction task system to likely be of interest to the user; and
providing the enhanced data related to the item of interest that is generated by the human interaction task system for storage in a memory account associated with the user.

11. The method of claim 10, wherein the data determined to likely be of interest to the user is determined by the human interaction task system based at least in part on the user's intent in making the request related to the at least one item of interest.

12. The method of claim 10, wherein the data related to the item of interest includes one or more keywords.

13. The method of claim 10, wherein the data related to the item of interest includes an indication of a type of search to be conducted regarding the data related to the item of interest.

14. The method of claim 10 further comprising conducting a search for additional information regarding the item of interest.

15. The method of claim 14 further comprising providing the additional information for storage with the enhanced data related to the item of interest in the memory account associated with the user.

16. The method of claim 14 further comprising submitting the additional information to the human interaction task system to generate enhanced data related to the item of interest.

17. The method of claim 10 further comprising applying an automated algorithm to the data related to the item of interest to generate additional information regarding the item of interest.

18. The method of claim 17 further comprising providing the additional information for storage with the enhanced data related to the item of interest in the memory account associated with the user.

19. The method of claim 17 further comprising submitting the additional information to the human interaction task system to generate enhanced data related to the item of interest.

20. The method of claim 10 further comprising causing the enhanced data related to the at least one item of interest to be displayed.

21. The method of claim 10 further comprising making enhanced data related to the item of interest available to a different user.

22. The method of claim 21, wherein making enhanced data related to the item of interest available to the different user comprises sending a recommendation to the different user.

23. The method of claim 22, wherein the user is compensated for the recommendation if the different user takes an action based on the recommendation.

24. The method of claim 21, wherein enhanced data related to the item of interest is made available to the different user via at least one of an electronic message, a voice message or a user interface display.

25. The method of claim 10 further comprising providing an opportunity for the user to purchase the item of interest.

26. The method of claim 10 further comprising tagging the enhanced data related to the item of interest.

27. The method of claim 10 further comprising adding a notation to the enhanced data related to the item of interest.

28. The method of claim 10, wherein the enhanced data includes the data related to the item of interest obtained from the user.

29. The method of claim 10 further comprising initiating a search for other items related to the item of interest.

30. The method of claim 10, wherein the data related to the item of interest comprises at least one of visual data, aural data, cognitive data and tactile data.

31. The method of claim 10 further comprising providing enhanced data related to the item of interest that is stored in the memory account associated with the user to a network-based service.

32. The method of claim 31, wherein the network-based service comprises at least one of a retail service, a social network service and a message publication service.

33. A system for enhancing and storing data related to items of interest to a user, the system comprising:
a data store that maintains a memory account for the user; and
a computing device in communication with the data store, the computing device operative to:
obtain a request from the user related to the item of interest;
enhance data related to the item of interest with additional data determined by a human interaction task system to be related to the item of interest, the additional data comprising an identification of the item of interest and data that is determined by the human interaction task system to likely be of interest to the user; and
store the enhanced data related to the item of interest in the memory account for the user maintained in the data store.

34. The system of claim 33, wherein the data determined to likely be of interest to the user is determined by the human interaction task system based at least in part on the user's intent in making the request related to the at least one item of interest.

35. The system of claim 33, wherein the computing device is operative to further enhance the data related to the item of interest with additional information obtained in response to a search query.

36. The system of claim 33, wherein the computing device is operative to further enhance the data related to the item of interest with additional information obtained from an automated algorithm.

37. The system of claim 33, wherein the computing device is operative to provide enhanced data related to one or more items of interest stored in the memory account for the user to a computing device.

38. The system of claim 33, wherein the computing device is operative to provide enhanced data related to one or more items of interest stored in the memory account for the user to a computing device utilized by a different user.

39. The system of claim 33, wherein the computing device is operative to provide enhanced data related to one or more items of interest stored in the memory account for the user to a network-based service.

40. The system of claim 39, wherein the network-based service is a retail service.

41. The system of claim 39, wherein the network-based service is a social network service.

42. The system of claim 39, wherein the network-based service is a message publication service.

43. The system of claim 33, wherein the computing device is operative to receive a request from the user to share the enhanced data related to the item of interest that is stored in the memory account for the user with a different user.

44. The system of claim 43, wherein the request to share the enhanced data related to the item of interest with the different user is a recommendation related to the item of interest.

45. The system of claim 44, wherein the user is compensated for the recommendation if the different user takes an action based on the recommendation.

46. The system of claim 33, wherein the computing device is operative to generate a request for additional data

47. The system of claim 33, wherein the computing device is operative to receive a request to purchase the item of interest.

48. The system of claim 33, wherein the computing device is operative to receive a request to tag the enhanced data related to the item of interest.

49. The system of claim 33, wherein the computing device is operative to receive a request to add a notation to the enhanced data related to the item of interest.

50. The system of claim 33, wherein the computing device is operative to receive a request to search for additional information related to the enhanced data.

51. The system of claim 33, wherein the computing device is operative to store the enhanced data related to the item of interest in a profile associated with the user.

52. The system of claim 33, wherein the computing device is operative to receive a request to add the item of interest to a wish list for the user.

53. The system of claim 33, wherein the computing device is operative to allow a different user to access the enhanced data stored in the memory account for the user.

54. A computer-readable medium having a computer-executable component for enhancing and storing data related to an item of interest to a user, the computer-executable component comprising:
a memory enhancement component operative to:
obtain data related to an item of interest to a user;
enhance the data related to the item of interest with additional data determined by a human interaction task system to be related to the item of interest, the additional data comprising an identification of the item of interest and data that is determined by the human interaction task system to likely be of interest to the user; and
provide the enhanced data related to the item of interest for storage in a memory account associated with the user.

55. The computer-readable medium of claim 54, wherein the memory account is maintained by the memory enhancement component.

56. The computer-readable medium of claim 54, wherein the memory account is maintained by a network-based service.

57. The computer-readable medium of claim 54 further comprising a user interface component operative to generate a display of enhanced data related to one or more items of interest stored in the memory account associated with the user.

58. The computer-readable medium of claim 57 wherein the user interface component is operative to generate a display of enhanced data related to one or more items of interest shared with the user by a different user.

59. The computer-readable medium of claim 57, wherein the user interface component is operative to enable the user to share with a different user enhanced data related to one or more items of interest stored in the memory account associated with the user.

60. The computer-readable medium of claim 57, wherein the user interface component is operative to enable addition of a tag to the enhanced data related to one or more items of interest stored in the memory account associated with the user.

61. The computer-readable medium of claim 57, wherein the user interface component is operative to enable addition of a notation to the enhanced data related to one or more items of interest stored in the memory account associated with the user.

62. The computer-readable medium of claim 57, wherein the user interface component is operative to enable a search for additional information related to one or more items of interest stored in the memory account associated with the user.

63. The computer-readable medium of claim 57, wherein the user interface component is operative to enable sorting of the enhanced data related to one or more items of interest stored in the memory account associated with the user.

64. The computer-readable medium of claim 57, wherein the user interface component is operative to enable a different user to select enhanced data related to one or more items of interest stored in the memory account associated with the user for storage in a memory account associated with the different user.

65. The computer-readable medium of claim 54, wherein the data is obtained without an indication of a purpose for enhancing the data.

66. The computer-readable medium of claim 54, wherein the memory enhancement component is operative to generate a notification when the data is enhanced.

67. The computer-readable medium of claim 54, wherein the memory enhancement component is operative to generate a notification if the data is not enhanced.

68. The computer-readable medium of claim 54, wherein the memory enhancement component is operative to obtain feedback regarding performance of the memory enhancement component.

69. The computer-readable medium of claim 54, wherein the memory enhancement component is operative to further enhance the data related to the item of interest with profile information associated with the user.

70. The computer-readable medium of claim 54, wherein the memory enhancement component is operative to further enhance the data related to the item of interest with profile information associated with a device from which the data related to the item of interest to a user is obtained.

71. The computer-readable medium of claim 54, wherein the memory enhancement component is operative to continuously enhance the data related to the item of interest.

72. The computer-readable medium of claim 54, wherein the memory enhancement component is operative to provide enhanced data related to one or more items of interest stored in the memory account associated with the user to a network-based service.

73. The computer-readable medium of claim 54, wherein the memory account is associated with a group of users.

74. A system for enhancing and storing data related to items of interest to a user, the system comprising:
a data store that maintains a memory account for the user; and
a computing device in communication with the data store, the computing device operative to:
obtain a request from the user to enhance and store data related to the item of interest, wherein the request does not include an indication of the user's intent regarding how the data related to the item of interest is to be enhanced;
enhance the data related to the item of interest with additional data determined to likely be of interest to the user, wherein the additional data is determined to likely be of interest to the user based on an identification of the item of interest and a determination of the user's intent regarding how the data related to the item of interest is to be enhanced; and
store the enhanced data related to the item of interest in the memory account for the user maintained in the data store.

75. The system of claim 74, wherein the additional data is obtained from a human interaction task system.

76. The system of claim 74, wherein the computing device is operative to enhance the data related to the item of interest with additional data obtained in response to a search query.

77. The system of claim 74, wherein the computing device is operative to enhance the data related to the item of interest with additional data obtained from an automated algorithm.

78. The system of claim 74, wherein the computing device is operative to provide enhanced data related to one or more items of interest stored in the memory account for the user to a computing device.

79. The system of claim 74, wherein the computing device is operative to provide enhanced data related to one or more items of interest stored in the memory account for the user to a computing device utilized by a different user.

80. The system of claim 74, wherein the computing device is operative to provide enhanced data related to one or more items of interest stored in the memory account for the user to a network-based service.

81. The system of claim 74, wherein the computing device is operative to receive a request from the user to make enhanced data related to the item of interest that is stored in the memory account for the user available to a different user.

82. The system of claim 74, wherein the computing device is operative to enhance the data related to the item of interest with profile information associated with the user.

83. The system of claim 74, wherein the computing device is operative to enhance the data related to the item of interest with profile information associated with a device from which the data related to the item of interest to a user is obtained.
